(19) United States
(12) Patent Application Publication
(10) Pub. No.: US 2008/0292375 A1
(43) Pub. Date: Nov. 27, 2008

(54) Pigment-Adhering Apparatus For A Printer Device

(75) Inventors: Cheng-Wen Tsai, Taipei (TW); Ming-Chun Hsu, Taipei (TW); Chung-Yi Cheng, Taipei (TW)

Correspondence Address: BEVER HOFFMAN & HARMS, LLP;2099 Gateway Place, Suite 320, San Jose, CA, 95110, US

(73) Assignee: Lite-On Technology Corp., Taipei (TW)

(21) Appl. No.: 11/934,043

(22) Filed: Nov. 1, 2007

(30) Foreign Application Priority Data
May 23, 2007 (TW) 096118450

(51) Int. Cl. G03G 15/20

(52) U.S. Cl. 399/329

(57) ABSTRACT

A pigment-adhering apparatus for the printer device is provided. The pigment-adhering apparatus includes a pressing roller having two contacting components and a feeding component between the two contacting components. The feeding component transports an printed object to be printed and the pressing roller provides a pressure to a heat conducting film. The contacting components make the heat conducting film move with the pressing roller at the same speed.

### FIELD OF THE INVENTION

The present invention relates to an apparatus of a printer device, particular to a pigment-adhering apparatus for the printer device.

### BACKGROUND OF THE INVENTION

Please refer to FIG. 1 which was a side view of a conventional pigment-adhering apparatus for a printer device. The heating film 200 encircled a heater seat 201. A heater 202 was disposed in the heater seat 201. A pressing roller 100 was driven by a motor M and was separated from the heating film 200 to be opposite to the heater 202 in order to exert a pressure on the heating film 200. A printed object P was loaded a pigment D. When the printed object P with the pigment D was pressed and transferred through a pressing zone A located between the pressing roller 100 and the heating film 200, heat was transferred to the pigment D through the heating film 200 and the pigment D was pressed into a flat pigment D′. The most important thing relevant to the quality of the printing was there were no slide between the printed object P and the heating film 200. Thus, in the conventional printing as shown in FIG. 1 the solution was to increase the surface friction coefficient of pressing roller 100. Usually it meant that the surface of the pressing roller became coarser. Therefore, the surface of the heating film 200 was easy to be worn out. The heating film 200 was early to be broken down, especially at high printing speed, because the surface of the heating film 200 became coarser in the conventional technique. When the surface of the heating film 200 was pressed inwardly and carved to form a recess, a pigment mark made of the pigment D would be accumulated into the recess. Then, the pigment D was not printed and adhered on printed object P or the pigment D in the recess was erroneously printed on a wrong location of the printed object P. The quality of the printing was bad.

Please refer to FIG. 2 which was a side view of another conventional pigment-adhering apparatus for a printer device. The pigment-adhering apparatus contained a pressing roller 100 against which a heating film 200 was rolled and upon which the heating film 200 exerted a pressure. The heating film 200 encircled a film seat 203 which was connected to a printer housing B through a spring 204. The spring 204 provided an elastic force exerted on the pressing roller 100 by means of the film seat 203 and the heating film 200 so that the pressing roller 100 could be firmly adhered to the heating film 200. The difference between the conventional techniques of FIG. 1 and FIG. 2 was that in the conventional technique of FIG. 2 in order to directly transfer a circling force from the pressing roller 100 onto the heating film 2000, a driving wheel 101 was respectively disposed at both ends of pressing roller 100 to directly press the driving wheel 101 against the heating film 200 so as to avoid mismatching problem of a rotating speed between the heating film 200 and the pressing roller 100. Because a relatively large pressure existed between the pressing roller 100 and the heating film 200, a relatively large pressure existed between the driving wheel 101 and the heating film 200. In order to avoid distorting and wrinkling after the heating film 200 was extruded and pressed by the driving wheel 101, a reinforcement part 210 was added and disposed at the inner periphery of the heating film 200 which was located correspondent to the location of driving wheel 101. The reinforcement part 210 was combined and fixed with the heating film 200 to rotate together at the same time. By means of the support by the reinforcement part 210, the heating film 200 would not be distorted by an extrusion and pressure of the driving wheel 101. The heating film 200 could be smoothly driven by the driving wheel 101.

In view of the conventional technique of FIG. 2, the part of the heating film 200 with reinforcement part 210 was considered as a rigid reinforcement zone 200b useful for enduring the pressing and drawing of the driving wheel 101. A un-reinforcement zone 200a was formed between the two reinforcement zones 200b, 200b. A boundary line 200c was formed between the reinforcement zone 200b and the un-reinforcement zone 200a. The reinforcement zone 200b at the heating film 200 was a part having large hardness and density. The un-reinforcement zone 200a was formed by the material of the heating film 200. Because the material of the heating film 200 was thin and soft, the un-reinforcement zone 200a had a low hardness and density in comparison with the reinforcement zone 200b. Because the physical properties of the un-reinforcement zone 200a and the reinforcement zone 200b differed, the deformation amount of the reinforcement zone 200b when the reinforcement zone 200b was pressed by the driving wheel 101 was different from the deformation amount of un-reinforcement zone 200a. The shrinkage, deformation, twisting of the heating film 200 would occur at the boundary line 200c due to the difference in the deformation amounts at both sides of the boundary line 200c and the life of the heating film 200 was shortened.

It was difficult to combine the heating film 200 with the reinforcement part 210, for example, by an adhesive. Because of the above reasons, the adhesion force of the adhesive would gradually lost and the film would separate from another part, the sliding problem between the reinforcement part 210 and the heating film 200 would occur.

From the above, for the conventional pigment-adhering apparatus for the printer device, a innovative device is needed to be created to solve the sliding problem between the printed object and the heating film and to avoid damaging the heating film when the driving force of the pressing roller is maintained. Furthermore, the device can be applied to the printing system of carbon powers using a silicone oil when the driving force is maintained or enhanced. Thus, how to rectify the foresaid conventional drawback is the main purpose of the present invention.

### SUMMARY OF THE INVENTION

It is another object of the present invention to provide a pigment-adhering apparatus for a printer device, comprising:

a pressing roller having two contacting components, and a feeding component placed between the two contacting components for feeding a printed object;

a heat conducting film pressed against the pressing roller;

a supporting structure having a notch and disposed in the heat conducting film for supporting the heat conducting film; and

a heating apparatus disposed in the notch and contacting with the heat conducting film,

wherein the two contacting components contact with the heat conducting film so that the heat conducting film is moved by the two contacting components and rotated together with the pressing roller.

Preferably, the pressing roller further comprises a motor driving the pressing roller, the two contacting components comprise a rough surface pressing against a surface of the heat conducting film, the two contacting components further comprise a plurality of teeth engaging with the surface of the heat conducting film, and the two contacting components have a diameter larger than that of the feeding component.

Preferably, the two contacting components and the feeding component have separate arrangements, where the feeding component is a feeding roller and the two contacting components are two transmission wheels spaced from each other and disposed at both ends of the feeding roller.

It is another object of the present invention to provide a pigment-adhering apparatus for a printer device, comprising:

a heat conducting film;

a supporting structure having a notch and disposed within the heat conducting film for supporting the heat conducting film;

a heat apparatus disposed in the supporting structure, faced toward the notch and contacting with the heat conducting film; and

a pressing roller feeding a printed object for pressing the printed object against the heat conducting film so that the heat conducting film is firmly pressed against the heating apparatus at the notch.

Preferably, the pressing roller further comprises two rotation transmission parts at its both ends, between which a feeding component is disposed, the two rotation transmission parts are pressed against the heat conducting film so that the heat conducting film is moved by the two rotation transmission parts and rotated together with the pressing roller, the feeding component is coated with a material selected from one of tetra-fluoroethylene-fluoro-alkylvinylethyl copolymer (PFA material) and carbon powder, and the rotation transmission part is made of a rubber.

Preferably, the heating apparatus further comprises a heating base disposing a heating component, the heating component is selected from one of a halogen lamp and a ceramic heating device, the heating component is suspended on the heating base for radiating heat on the heating base, and the supporting structure comprises a first supporting component and a second supporting component disposed at both ends of the heat conducting film to extend and secure the heating apparatus.

In accordance with the present invention, there is provided a film supporting mechanism of a pigment-adhering apparatus for supporting a heat conducting film comprising a notch.

Preferably, the pigment-adhering apparatus further comprises the heat conducting film disposed on and supported by the film supporting mechanism, and a heating apparatus contacts with the heat conducting film through the notch.

In accordance with the present invention, there is provided a pigment-adhering apparatus for a printer device, comprising:

a pressing roller having two contacting components between which a feeding component feeding a printed object is disposed; and

a heat conducting film contacting with the two contacting components and driven by the two contacting components to rotate together with the pressing roller.

Preferably, a first friction coefficient exists between the respective contacting component and the heat conducting film, a second friction coefficient exists between the feeding component and the heat conducting film, where the first friction coefficient is larger than the second friction coefficient, the feeding component is a feeding roller, the two contacting components are two transmission wheels spaced between two ends of the feeding roller, the feeding roller is co-axial with the two transmission wheels, the two contacting components having a rough surface pressing against a surface of the heat conducting film, the two contacting components further comprise a plurality of teeth engaging with the surface of the heat conducting film, the two contacting components have a diameter larger than that of the feeding component, and the heat conducting film further comprises a heating apparatus heating by contacting with an inner surface of the heat conducting film.

Preferably, the pigment-adhering apparatus further comprises:

a supporting structure having a notch and disposed within the heat conducting film; and

a heating apparatus disposed in the notch and contacting with the heat conducting film.

Preferably, the supporting structure comprises a first supporting portion and a second supporting portion which are respectively disposed at both ends of the heat conducting film and fixed to the heat apparatus.

Preferably, the heating apparatus further comprises a heating base disposing thereon a heating component, the heating component is selected from one of a halogen lamp and a ceramic heating device, and the heating component is suspended on the heating base for radiating heat on the heating base.

According to another aspect of the present invention, there is provided a pigment-adhering apparatus for a printer device having a pressurizing apparatus, comprising:

two contacting components; and

a feeding component disposed between the two contacting components for feeding a printed object,

wherein the pressurizing apparatus exerts a pressure on a heat conducting film driven by the two contacting components so that the heat conducting film is rotated together with the pressurizing apparatus.

Preferably, the pressurizing apparatus is a roller-like structure and the two contacting components are formed at both ends of the roller-like structure.

Preferably, the two contacting components are two transmission wheels, the feeding component is a feeding roller and the two transmission wheels are separately disposed at both ends of the feeding roller.

Preferably, a surface friction coefficient of the two contacting components is larger than that of the feeding component.

Preferably, a pressure exerted by the two contacting components on the heat conducting film is larger than that exerted by the feeding component.

The foregoing and other features and advantages of the present invention will be more clearly understood through the following descriptions with reference to the drawings, wherein:

### BRIEF DESCRIPTION OF THE DRAWINGS

FIG. 1 is a schematic side view showing a pigment-adhering apparatus for a printer device according to the prior art;

FIG. 2 is a sectional front view showing the structures of another pigment-adhering apparatus for a printer device according to the prior art;

FIG. 3 is a three-dimensional view showing a pigment-adhering apparatus for a printer device according to the present invention;

FIG. 4 is a schematic front view showing a pigment-adhering apparatus for a printer device according to the present invention;

FIG. 5 is a sectional side view showing a pigment-adhering apparatus for a printer device according to the present invention;

FIG. 6 is a sectional side view showing a pigment-adhering apparatus for a printer device according to the present invention; and

FIG. 7-9 are front views showing a pigment-adhering apparatus for a printer device of the present invention.

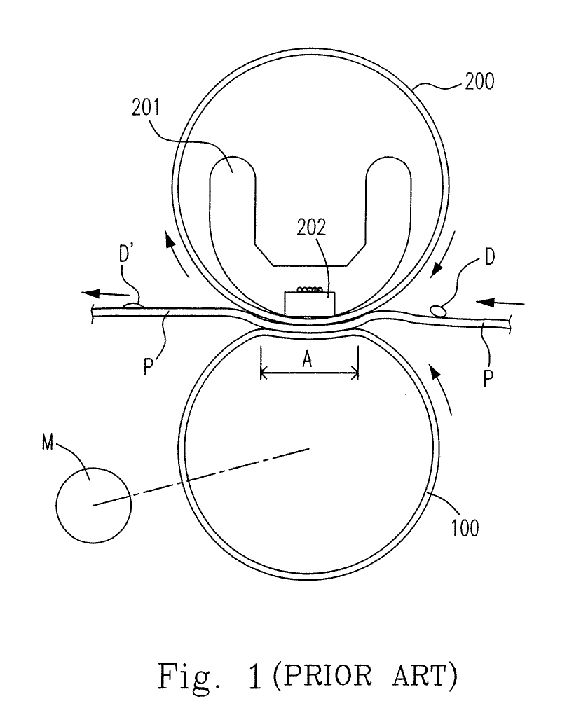

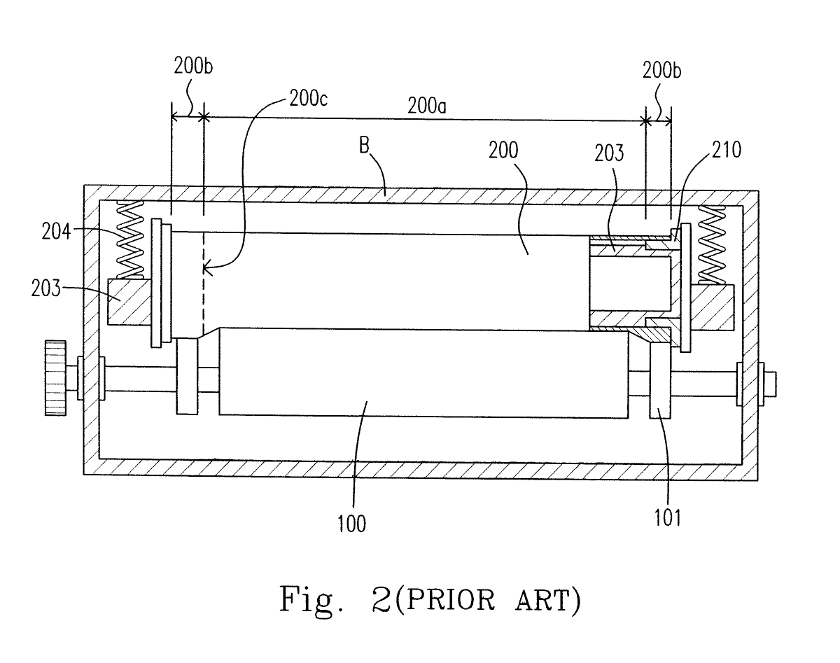

### DETAILED DESCRIPTION OF THE PREFERRED EMBODIMENT

The present invention will now described more specifically with reference to the following embodiments. In order to improve the drawbacks of conventional techniques of heat conducting film, in this present invention, the improved method is to increase a regional friction force between a heat conducting film and pressing wheels so as to increase a driving force of the heat conducting film and at the same time not to destroy the effect of the heat conducting film.

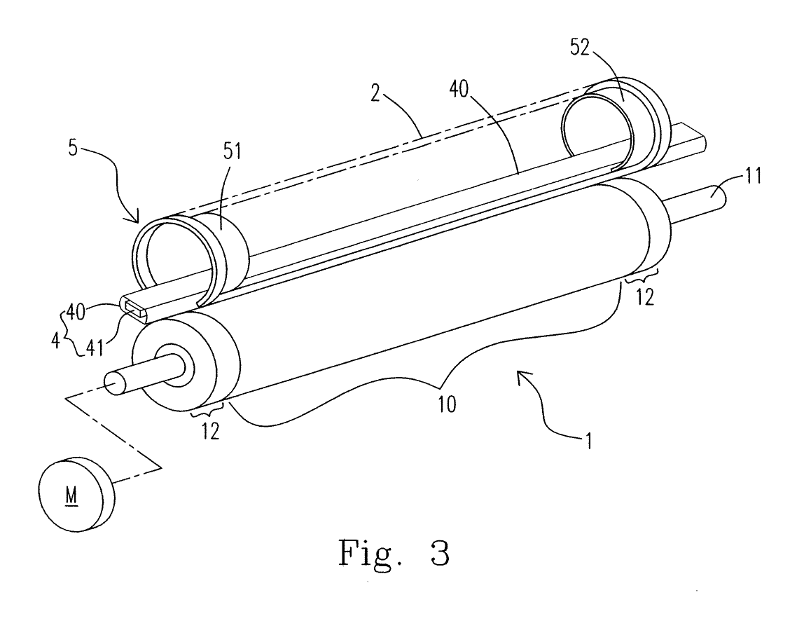

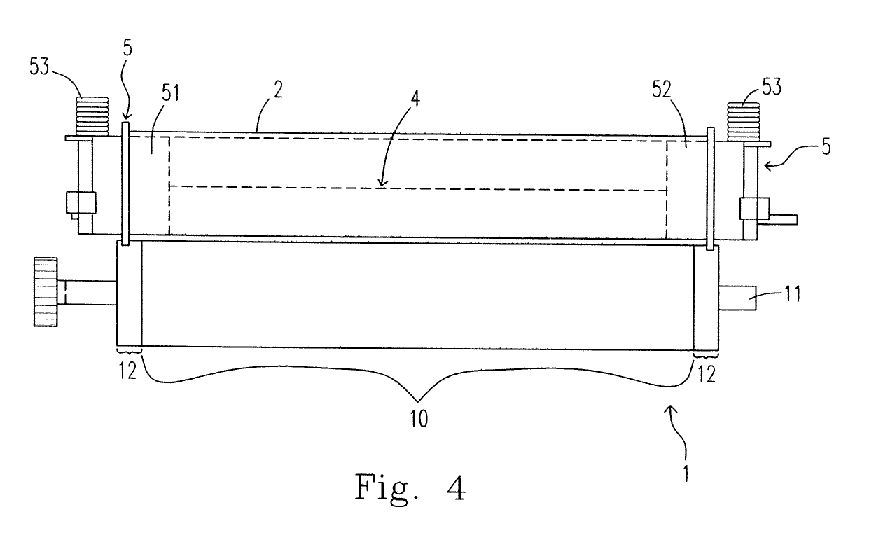

Please refer to FIG. 3 which is a three-dimensional view of a pigment-adhering apparatus for a printer device of the present invention. Please refer to FIG. 4 which is a front view of a pigment-adhering apparatus for a printer device of the present invention. The pressing device 1 contains two contacting components 12, 12 and a feeding component 10. The two contacting components 12, 12 are respectively disposed at both ends of the feeding component 10, i.e. at outer side of the pressing device 1. The pressing device 1 is obviously a roller structure to be called as a pressing roller 1. The pressing roller 1 is driven by a motor M (only shown in FIG. 3) via a shaft 11 to transmit a rotating force to a heat conducting film 2 through two contacting components 12, 12 to drive it to move. The heat conducting film 2 is supported by a supporting structure 5 into which the heat conducting film 2 is inserted. The supporting structure 5 contains a first supporting component 51 and a second supporting component 52 which are respectively disposed at both ends of the heat conducting film 2 pressed by the two contacting components 12, 12. The first and second supporting components 51, 52 are used to support the heat conducting film 2 to resist pressing from the contacting components 12, 12 and to maintain in its relatively suitable position when the heat conducting film 2 is pressed against the pressing roller 1. A heating apparatus 4 comprising a heating base 40 connected to the supporting structure 5 and a heating component 41 (shown in FIG. 3) disposed in the heating base 40, is disposed in the supporting structure 5. Usually the heating component 41 is hung in the heating base 40 and does not contact with the heating base 40. The heating component 41 irradiate on the heat seat 40 to make its temperature increase. The vertical position of the heating base 40 can be slightly regulated by two pressing springs 53, 53 according to exerting force of the pressing springs 53, 53. In order to completely support the heat conducting film 2, the supporting structure 5 can pass through the heat conducting film 2, i.e. the first supporting component 51 can extend all the way to the second supporting component 52 as a whole.

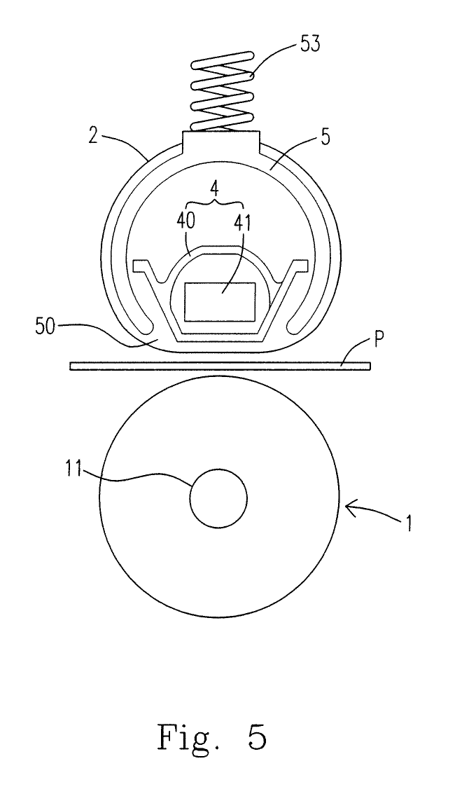

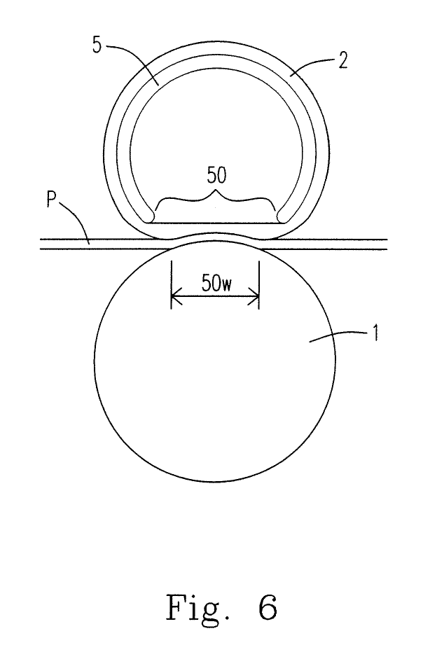

Please refer to FIG. 5 which is a side view of the pigment-adhering apparatus for a printer device of the present invention. The heat conducting film 2 and the pressing roller 1 are disposed adjacent to each other. The pressing roller 1 is driven by the shaft 11 and a printed object P is inserted therebetween. The supporting structure 5 in the heat conducting film 2 has a notch 50 useful for placing the heating apparatus 4. In FIG. 5, the heating base 40, heating component 41 and the heat conducting film 2 are placed relative to the position of the supporting structure 5. A pressing spring 53 is mounted on the supporting structure 5. Please refer to FIG. 6 which is side view of the pigment-adhering apparatus for a printer device of the present invention. The drawing of the heating apparatus 4 is ignored to significantly show a design of the notch 50. Because of the design of the notch 50, the cross section of the heat conducting film 2 is not circular and is exhibited to be planar near the notch 50. A advantage of the notch 50 is that when the heat conducting film 2 is pressed by the pressing roller 1, the area of the heat conducting film 2 which is pressed against the pressing roller 1 can be larger. In theory, the width of the notch 50 is bigger, the width 50w which is extended by the heat conducting film 2 is larger. The width 50w shall not be so large that the shape of the heat conducting film 2 deviate from a shape of circle and that the heat conducting film 2 can not be driven to move smoothly. Please refer to FIGS. 5 and 6. If a thickness of the printed object P changes, the distance between the pressing roller 1 and the heat conducting film 2 varies. If the thickness of the printed object P is smaller, the heat conducting film 2 is forced to be pressed downwardly to approach the pressing roller 1 by a elastic force of the pressing spring 53. On the contrary, if the thickness of the printed object P is larger, the heat conducting film 2 is forced to be moved upwardly to drive the supporting structure 5 move upwardly so that the pressing spring 53 can absorb upward movement of the supporting structure 5 and can provide a enough elastic force toward the heat conducting film 2 in order to firmly press against the pressing roller 1. Then, it can be confirmed that the pressing roller 1, printed object P, heat conducting film 2 and the heating base 40 are firmly contacting with each other in order to make the heating process more homogeneous. Because the width 50w become larger, a spot on the printed object P is heated for longer duration for absorbing enough heat, the hot stamp can obtain better effects. Therefore, the printing speed can increase.

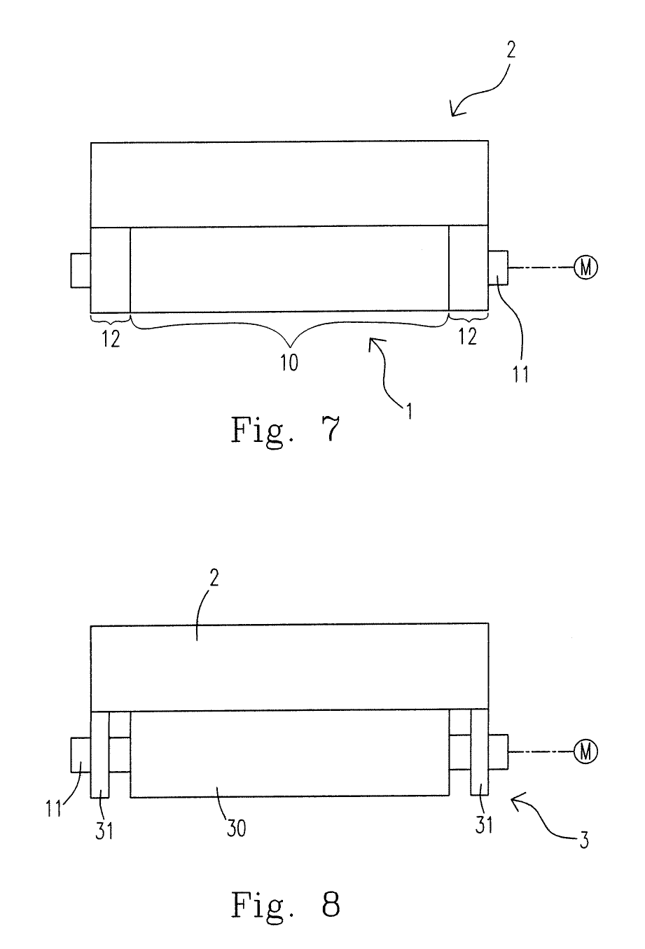

Please refer to FIGS. 7-9 which are front views of the pigment-adhering apparatus for a printer device of the present invention showing the working examples. From FIG. 7, the pressing roller 1 contains two contacting components 12, 12 and a feeding component 10. The two contacting components 12, 12 are disposed at both ends of the feeding component 10 which are outer side of the pressing roller 1. The pressing roller 1 is driven to move by the motor M via the shaft 11. The heat conducting film 2 is driven to move by the friction force between the heat conducting film 2 and the two contacting components 12, 12.

In the working example of FIG. 8, the pressing assembly 3 contains a feeding roller 30 and two transmission wheels 31, 31 which commonly use the shaft 11. The difference between FIG. 7 and FIG. 8 is that the transmission wheel 31 is obviously separated from the feeding roller 30. The transmission wheel 31 and the feeding roller 30 can be dismantled and mounted respectively. The space occupied by the transmission wheel 31 and the feeding roller 30 is divided. The foreign bodies adhered on the feeding roller 30 and the remnants after friction the transmission wheel 31 will not move to a surface of the other side. It will insure the efficiency of feeding a printed object by the feeding roller 30 and the efficiency of driving the heat conducting film 2 by the transmission wheel 1.

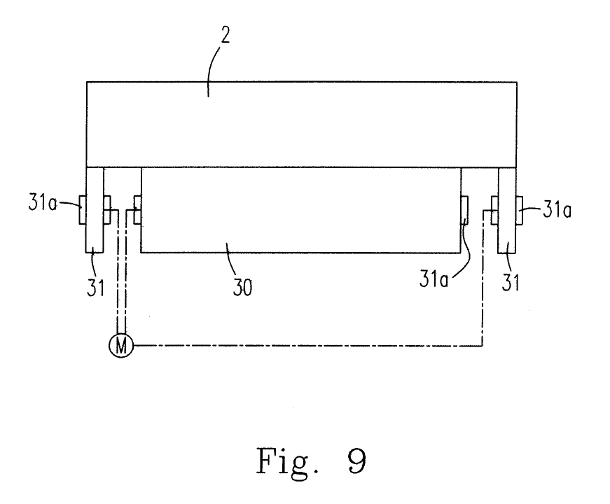

In the working example of FIG. 9, the feeding roller 30 is separated from the two transmission wheels 31 and is not co-axial with the two transmission wheels 31. The feeding roller 30 is connected to a motor M via a feeding shaft 30a while the transmission wheel 31 is connected to the motor M via a wheel shaft 31a. Please refer to FIG. 6. a contacting component 12 is specially designed on the pressing roller 1 and used to directly contact with the heat conducting film 2 to directly drive it. One method of them is to applying tetra-fluoroethylene-fluoro-alkylvinylethyl copolymer (PFA material) or other materials which can render the carbon non-sticking on the feeding component 10. The above materials are not applied on the surface of the contacting component 12. A rubber of high sticking property which is a material of the pressing roller 1 can contact with the heat conducting film 2 to smoothly drive it. Alternatively, a material of high friction coefficient is applied on the surface of the contacting component 12, for example, the surface of the contacting component 12 is formed as rough surface of protrudents to form a sand paper-like surface to be pressed into the heat conducting film 2. Alternatively, a teeth-like structure is formed on the surface of the contacting component 12 to engage the heat conducting film 2 to drive by force. In the working example of FIG. 8, the transmission wheel 31 can be substituted by a roller having concentrated engraved marks or raised surfaces. Therefore, if the pressure on the heat conducting film 2 is not increased, the driving force of the pressing roller 1 to drive the heat conducting film 2 is increased in the present invention. Please refer to FIGS. 4-6. Because a notch 50 is formed on the supporting structure 5 of the present invention, the pressing force exerted by the contacting component 12 on the heat conducting film 2 is simply increased in order to increase the driving force on the heat conducting film 2. In the same way, in the working example of FIG. 9, the pressing force exerted by the transmission wheel 31 on the heat conducting film 2 is simply increased and the pressing force received by the heat conducting film 2 is absorbed by the supporting structure 5.

In conclusion, the creativity and inventive step of the present invention are that the heat conducting film 2 can be driven by means of the contacting component 12 shown in FIGS. 3 and 7 or by means of the transmission wheel 31 shown in FIGS. 8 and 9 in order that the heat conducting film 2 and the printed object P both are moved at the same speed to avoid sliding between the heat conducting film 2 and the printed object P and unclearly printing. Because arc sliding of the heat conducting film 2 happens on the notch 50 of the supporting structure 5 and no other objects are added on the heat conducting film 2, the heat conducting film 2 is an object of even density and the difference in regional structure of the heat conducting film rendered by other added components on the heat conducting film in prior arts will not happen so as not to be deformed because the pressing roller drives at the adjacent regions having different structures. Furthermore, by means of the notch of the supporting structure, the area of the heat conducting film contacting with the contacting component increases in order to receive more driving force and the area of heating increases in order to increase the transferred heat amount. In other words, at the same condition that same amount of heat is input in the conventional printing apparatus, the present invention can decrease the duration of printed object P stayed between the heat conducting film 2 and the pressing roller 1 and the printing speed increases. The printing quality and efficiency of the pigment-adhering apparatus for the printer device of the present invention increase.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A pigment-adhering apparatus for a printer device, comprising:
a pressing roller having two contacting components, and a feeding component placed between the two contacting components for feeding a printed object;
a heat conducting film pressed against the pressing roller;
a supporting structure having a notch and disposed in the heat conducting film for supporting the heat conducting film; and
a heating apparatus disposed in the notch and contacting with the heat conducting film,
wherein the two contacting components contact with the heat conducting film so that the heat conducting film is moved by the two contacting components and rotated together with the pressing roller.

2. The pigment-adhering apparatus for the printer device according to claim 1, wherein the pressing roller further comprises a motor driving the pressing roller, the two contacting components comprise a rough surface pressing against a surface of the heat conducting film, the two contacting components further comprise a plurality of teeth engaging with the surface of the heat conducting film, and the two contacting components have a diameter larger than that of the feeding component.

3. The pigment-adhering apparatus for the printer device according to claim 2, wherein the two contacting components and the feeding component have separate arrangements, where the feeding component is a feeding roller and the two contacting components are two transmission wheels spaced from each other and disposed at both ends of the feeding roller.

4. A pigment-adhering apparatus for a printer device, comprising:
a heat conducting film;
a supporting structure having a notch and disposed within the heat conducting film for supporting the heat conducting film;
a heating apparatus disposed in the supporting structure, faced toward the notch and contacting with the heat conducting film; and
a pressing roller feeding a printed object for pressing the printed object against the heat conducting film so that the heat conducting film is firmly pressed against the heating apparatus at the notch.

5. The pigment-adhering apparatus for the printer device according to claim 4, wherein the pressing roller further comprises two rotation transmission parts at its both ends, between which a feeding component is disposed, the two rotation transmission parts are pressed against the heat conducting film so that the heat conducting film is moved by the two rotation transmission parts and rotated together with the pressing roller, the feeding component is coated with a material selected from one of tetra-fluoroethylene-fluoro-alkylvinylethyl copolymer (PFA material) and carbon powder, and the rotation transmission part is made of a rubber.

6. The pigment-adhering apparatus for the printer device according to claim 4, wherein the heating apparatus further comprises a heating base disposing a heating component, the heating component is selected from one of a halogen lamp and a ceramic heating device, the heating component is suspended on the heating base for radiating heat on the heating base, and the supporting structure comprises a first supporting component and a second supporting component disposed at both ends of the heat conducting film to extend and secure the heating apparatus.

7. A film supporting mechanism of a pigment-adhering apparatus for supporting a heat conducting film comprising a notch.

8. The film supporting mechanism according to claim 7, wherein the pigment-adhering apparatus further comprises the heat conducting film disposed on and supported by the film supporting mechanism, and a heating apparatus contacts with the heat conducting film through the notch.

9. A pigment-adhering apparatus for a printer device, comprising:
a pressing roller having two contacting components between which a feeding component feeding a printed object is disposed; and
a heat conducting film contacting with the two contacting components and driven by the two contacting components to rotate together with the pressing roller.

10. The pigment-adhering apparatus for the printer device according to claim 9, wherein a first friction coefficient exists between the respective contacting component and the heat conducting film, a second friction coefficient exists between the feeding component and the heat conducting film, where the first friction coefficient is larger than the second friction coefficient, the feeding component is a feeding roller, the two contacting components are two transmission wheels spaced between two ends of the feeding roller, the feeding roller is co-axial with the two transmission wheels, the two contacting components have a rough surface pressing against a surface of the heat conducting film, the two contacting components further comprise a plurality of teeth engaging with the surface of the heat conducting film, the two contacting components have a diameter larger than that of the feeding component, and the heat conducting film further comprises a heating apparatus heating by contacting with an inner surface of the heat conducting film.

11. The pigment-adhering apparatus for the printer device according to claim 10, further comprising:
a supporting structure having a notch and disposed within the heat conducting film; and
a heating apparatus disposed in the notch and contacting with the heat conducting film.

12. The pigment-adhering apparatus for the printer device according to claim 11, wherein the supporting structure comprises a first supporting portion and a second supporting portion which are respectively disposed at both ends of the heat conducting film and fixed to the heat apparatus.

13. The pigment-adhering apparatus for the printer device according to claim 11, wherein the heating apparatus further comprises a heating base disposing thereon a heating component, the heating component is selected from one of a halogen lamp and a ceramic heating device, and the heating component is suspended on the heating base for radiating heat on the heating base.

14. A pigment-adhering apparatus for a printer device having a pressurizing apparatus, comprising:
two contacting components; and
a feeding component disposed between the two contacting components for feeding a printed object;
wherein the pressurizing apparatus exerts a pressure on a heat conducting film driven by the two contacting components so that the heat conducting film is rotated together with the pressurizing apparatus.

15. The pigment-adhering apparatus for the printer device according to claim 14, wherein the pressurizing apparatus is a roller-like structure and the two contacting components are formed at both ends of the roller-like structure.

16. The pigment-adhering apparatus for the printer device according to claim 14, wherein the two contacting components are two transmission wheels, the feeding component is a feeding roller and the two transmission wheels are separately disposed at both ends of the feeding roller.

17. The pigment-adhering apparatus for the printer device according to claim 14, wherein a surface friction coefficient of the two contacting components is larger than that of the feeding component.

18. The pigment-adhering apparatus for the printer device according to claim 14, wherein a pressure exerted by the two contacting components on the heat conducting film is larger than that exerted by the feeding component.
